(19) United States
(12) Patent Application Publication
(10) Pub. No.: US 2019/0313201 A1
(43) Pub. Date: Oct. 10, 2019

(54) SYSTEMS AND METHODS FOR SOUND EXTERNALIZATION OVER HEADPHONES

(71) Applicant: Bose Corporation, Framingham, MA (US)

(72) Inventors: Wade P. Torres, Attleboro, MA (US); Daniel R. Tengelsen, Framingham, MA (US); Mikaela A. Shannon, Brookline, MA (US)

(73) Assignee: Bose Corporation, Framingham, MA (US)

(21) Appl. No.: 15/945,449

(22) Filed: Apr. 4, 2018

(51) Int. Cl. H04S 7/00; H04R 5/033; H04R 5/04; H04S 3/00

(52) U.S. Cl. CPC H04S 7/304; H04R 5/033; H04R 5/04; H04S 2420/01; H04S 2400/01; H04S 2400/11; H04S 3/008

(57) ABSTRACT

A system and method for externalizing sound. The system includes a headphone assembly and a localizer configured to collect information related to a location of the user and of an acoustically reflective surface in the environment. A controller is configured to determine a location of a virtual sound source, and generate head related transfer functions that simulate characteristics of sound from the virtual sound source directly to the user and to the user via a reflection by the reflective surface. A signal processing assembly is configured to create one or more output signals by filtering the sound signal respectively with the HRTFs. Each speaker of the headphone assembly is configured to produce sound in accordance with the output signal.

### BACKGROUND

The disclosure relates to methods, devices, and systems for using sound externalization over headphones to augment reality.

### SUMMARY

All examples and features mentioned below can be combined in any technically possible way.

In an aspect, a sound externalization system includes a localizer configured to collect information related to a first location of a user in an environment and a second location of an acoustically reflective surface in the environment; a controller configured to: determine a third location of a virtual sound source in the environment; generate a first left head related transfer function (HRTF) and a first right HRTF that simulate characteristics of sound from the virtual sound source directly to the user; determine a reflected sound path from the virtual sound source to the user that includes a reflection of sound by the acoustically reflective surface; generate a second left HRTF and a second right HRTF that simulates characteristics of sound from the reflective surface to the user; and generate a sound signal corresponding to the virtual sound source.

Embodiments may include the controller configured to determine the reflected sound path by determining a fourth location corresponding to a reflection of the virtual sound source by the reflective surface, the reflected sound path comprising a direct path from the fourth location to the first location. The system may include a plurality of the acoustically reflective surfaces, wherein the reflected sound path represents at least one higher-order reflection off of two or more of the acoustically reflective surfaces.

Embodiments may include one of the following features, or any combination thereof. The system may further include a headphone assembly configured to be worn by the user and having: a left speaker and a right speaker; and a signal processing circuit configured to create first left, second left, first right, and second right output signals, respectively, by filtering the sound signal with the first left, second left, first right, and second right HRTFs; wherein the left speaker is configured to produce sound in accordance with the first and second left output signals and the right speaker is configured to produce sound in accordance with the first and second right output signals.

Embodiments may include the signal processing circuit being configured to sum the first and second left output signals and to sum the first and second right output signals. The first location, the second location, and third location may be determined relative to each other.

Embodiments may include the system having an acoustic characteristic detector configured to collect data related to reverberation characteristics of the environment or the acoustically reflective surface, wherein the controller is configured to determine an absorption coefficient for the environment or for the acoustically reflective surface from the data.

Embodiments may include the system further having a display configured to display an avatar representing the virtual sound source at the third location when the third location is viewed through the display. The display may be included by a smartphone or other mobile computing device.

Embodiments may include the localizer being a rangefinder, a proximity sensor, an ultrasonic sensor, a camera, an infrared camera, or a combination including at least one of the foregoing. The localizer may be at least one sensor integrated in the headphone assembly. The localizer may be at least one sensor external to the headphone assembly. The localizer may be configured to obtain electronic data representative of a map of the environment that indicates surfaces of the acoustically reflective surface.

Embodiments may include the acoustically reflective surface having one or more walls, floors, ceilings, or a combination including at least one of the foregoing.

Embodiments may include the system having a motion tracker configured to collect data related to an orientation of the user. The motion tracker may include a proximity sensor, an ultrasonic sensor, an infrared sensor, a camera, an accelerometer, a gyroscope, an inertial motion sensor, an external camera, or a combination including at least one of the foregoing. The controller may be configured to determine one or more angles between the orientation of the user and a directionality of sound from the third location, from the reflective surface, or both, and the one or more angles are utilized by the controller when generating the first left, second left, first right, and second right HRTFs.

Embodiments may include the controller being configured to recalculate the first left, second left, first right, and second right HRTFs in response to the system detecting relative movement between any combination of the user, the third location of the virtual sound source, and the acoustically reflective surface. The controller may be configured to move the virtual sound source by changing the third location.

In another aspect, a sound externalization system includes a headphone assembly worn by a user; a sensor configured to detect an acoustically reflective surface in an environment in which the user is located; a controller configured to: associate a first location in the environment with a virtual sound source; determine a second location of the user; determine reflected sound path simulating sound from the first location to the user that includes a reflection of sound by the acoustically reflective surface at a third location; generate a first head related transfer function simulating characteristics of sound traveling from the first location to the second location; generate a second head related transfer function simulating characteristics of sound traveling from the third location to the second location; generate a sound signal for the virtual sound source; generate a first output signal by filtering the sound signal with the first head related transfer function and a second output signal by filtering the sound signal with the second head related transfer function; and a speaker of the headphone assembly configured to produce sound in accordance with the first and second output signals.

In another aspect, a method for externalizing sound from a headphone assembly worn by a user includes associating a virtual sound source with a physical location in an environment in which the user is located; identifying one or more acoustically reflective surfaces in the environment; determining a reflected sound path from the physical location to the user that includes at least one reflection by the acoustically reflective surface; generating a first head related transfer function (HRTF) simulating characteristics of sound received by the user directly from the physical location; generating a second HRTF simulating characteristics of sound received by the user from the reflective surface; generating a sound signal corresponding to the virtual sound source; filtering the sound signal with the first HRTF to generate a first output signal; filtering the sound signal with the second HRTF to generate a second output signal; and producing sound with a speaker of the headphone assembly in accordance with the first and second output signals.

Embodiments may include tracking relative movement between any combination of the user, the physical location associated with the virtual sound source, and the acoustically reflective surface, wherein the tracking occurs continuously during the method.

### BRIEF DESCRIPTION OF THE DRAWINGS

FIG. 1 is a schematic view illustrating head related transfer functions characterizing sound received by a user.

FIG. 2 is a schematic view illustrating direct and reflected sound paths from a virtual sound source to a headphone assembly in a sound externalization system according to one embodiment disclosed herein.

FIG. 3 is a block diagram of a sound externalization system according to one embodiment disclosed herein.

FIG. 4 is a flowchart illustrating a method of sound externalization according to one embodiment disclosed herein.

FIGS. 5-6 illustrate example scenarios utilizing a display to supplement the sound externalization systems disclosed herein with visual augmentation.

### DETAILED DESCRIPTION

The present disclosure describes various systems and methods for sound externalization over headphones. When listening to audio over headphones, particularly stereo headphones, many listeners perceive the sound as coming from “inside their head”. Headphone externalization refers to the process of making sounds that are rendered over headphones sound as though they are coming from the surrounding environment, i.e. the sounds are “external” to the listener. The combination of head tracking and the use of head related transfer functions (HRTFs) can be used to give the listener some cues that help them perceive the sound as though it were coming from “outside their head”. The present disclosure appreciably recognizes that additional cues may be added that are consistent with the listener's surroundings to significantly improve the perceived externalization. More specifically, the first early reflections from acoustically reflective surfaces such as the walls, ceiling, floor, and other objects in the room may be synthetically generated and appropriately filtered with the corresponding HRTF that is consistent with respect to the reflection's direction of arrival.

To this end, the location of the listener in the room or environment, the location of the virtual sound source, and the location of any acoustically reflective surfaces (typically walls, ceiling, floor, etc.) is determined. This information can be ascertained, for example, via active scanning or monitoring by sensors or other cameras, or by manually measuring an area and creating a corresponding digital map. By dynamically and continually updating sensor information about the environment, a system can be created that externalizes sound no matter where the listener is and even as the listener moves around the environment.

The term “head related transfer function” or acronym “HRTF” is intended to be used broadly herein to reflect any manner of calculating, determining, or approximating head related transfer functions. For example, a head related transfer function as referred to herein may be generated specific to each user, e.g., taking into account that user's unique physiology (e.g., size and shape of the head, ears, nasal cavity, oral cavity, etc.). Alternatively, a generalized head related transfer function may be generated that is applied to all users, or a plurality of generalized head related transfer functions may be generated that are applied to subsets of users (e.g., based on certain physiological characteristics that are at least loosely indicative of that user's unique head related transfer function, such as age, gender, head size, ear size, or other parameters). In one embodiment, certain aspects of the head related transfer function may be accurately determined, while other aspects are roughly approximated (e.g., accurately determines the interaural delays, but coarsely determines the magnitude response).

The term “headphone” as used herein is intended to mean any sound producing device that is configured to fit around, on, in, or proximate to a user's ear in order to radiate acoustic energy into or received by the user's ear canal. Headphones may be referred to as earphones, earpieces, earbuds, or ear cups, and can be wired or wireless. Headphones may be integrated into another wearable device, such as a headset, helmet, hat, hood, smart glasses or clothing, etc. A headphone may include an acoustic driver to transduce audio signals to acoustic energy. The acoustic driver may be housed in an ear cup or earbud. A headphone may be a single stand-alone unit or one of a pair of headphones, such as one headphone for each ear. A headphone may be connected mechanically to another headphone, for example by a headband and/or by leads that conduct audio signals to an acoustic driver in the headphone. A headphone may include components, e.g., a microphone, for wirelessly receiving audio signals. A headphone may include components of an active noise reduction (ANR) and/or passive noise reduction (PNR) system.

The term “augmented reality” or acronym “AR” as used herein is intended to include systems in which a user may encounter, with one or more of their senses (e.g., using their sense of sound, sight, touch, etc.), elements from the physical, real-world environment around the user that have been combined, overlaid, or otherwise augmented with one or more computer-generated elements that are perceivable to the user using the same or different sensory modalities (e.g., sound, sight, haptic feedback, etc.). The term “virtual” as used herein refers to this type of computer-generated augmentation that is produced by the systems and methods disclosed herein. In this way, a “virtual sound source” as referred to herein corresponds to a physical location in the real-world environment surrounding a user which is treated as a location from which sound radiates, but at which no sound is actually produced by an object. In other words, the systems and methods disclosed herein may simulate a virtual sound source as if it were a real object producing a sound at the corresponding location in the real world. In contrast, the term “real”, such as “real object”, refers to things, e.g., objects, which actually exist as physical manifestations in the real-world area or environment surrounding the user.

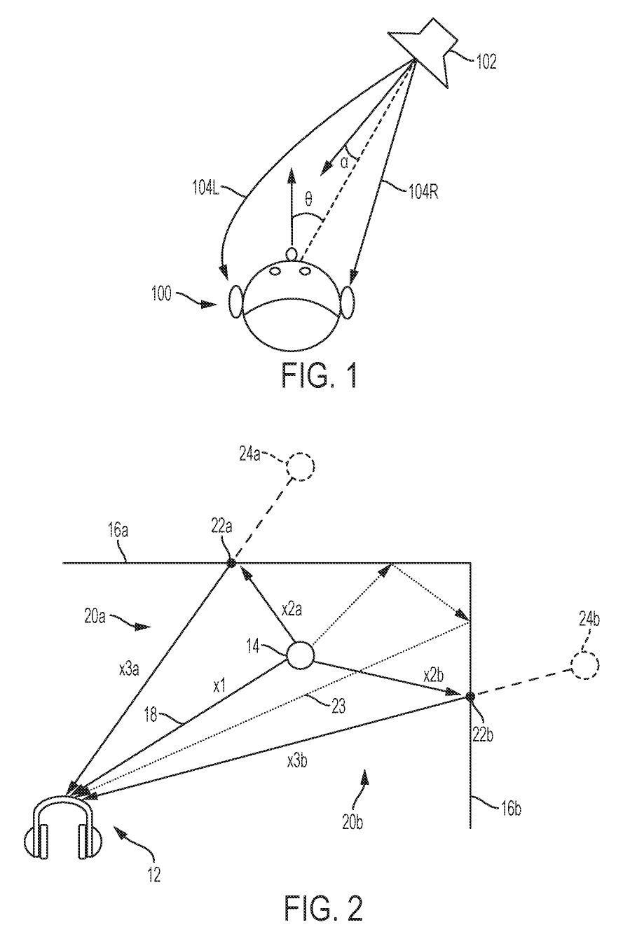

FIG. 1 schematically illustrates a user 100 receiving sound from a sound source 102. As noted above, HRTFs can be calculated that characterize how the user 100 receives sound from the sound source, and are represented by arrows as a left HRTF 104L and a right HRTF 104R (collectively or generally HRTFs 104). The HRTFs 104 are at least partially defined based on an orientation of the user with respect to the sound source, indicated by an angle θ, and a directionality of the sound produced by the sound source, indicated by an angle α. That is, the angle θ represents the difference between the direction that the user 100 is facing with respect to the direction at which the sound source 102 is located (represented by a dashed line), while the angle α represents the difference between the primary direction in which the sound source 102 is producing sound and the direction at which the user 100 is located with respect to the sound source 102.

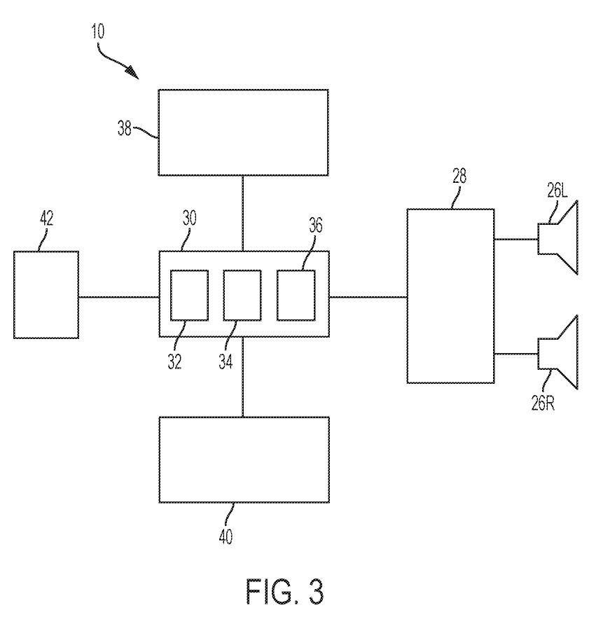

FIG. 2 depicts a sound externalization system 10 that includes a headphone assembly 12, e.g., including a first speaker configured to be arranged with respect to a user's left ear and/or a right speaker configured to be arranged with respect to a user's right ear. As discussed herein, the sound externalization system 10 may be used with or as an augmented reality system, specifically, to create acoustic augmentations to reality. The system 10 is configured to set, obtain, or generate a physical location for a virtual sound source 14. That is, despite the virtual sound source 14 being virtual, i.e., a computer-generated construct that does not exist in the real world, a physical location in the real world is associated with the virtual sound source 14. In this way, the system 10 is able to produce sound for the user that simulates the sound for the user as if the virtual sound source 14 were a physical object in the real world producing the sound. The system 10 utilizes the location corresponding to the virtual sound source 14 to calculate head related transfer functions (HRTFs) to simulate how the user would have heard the sound produced by the virtual sound source 14 if the virtual sound source 14 were a physical object in the real world.

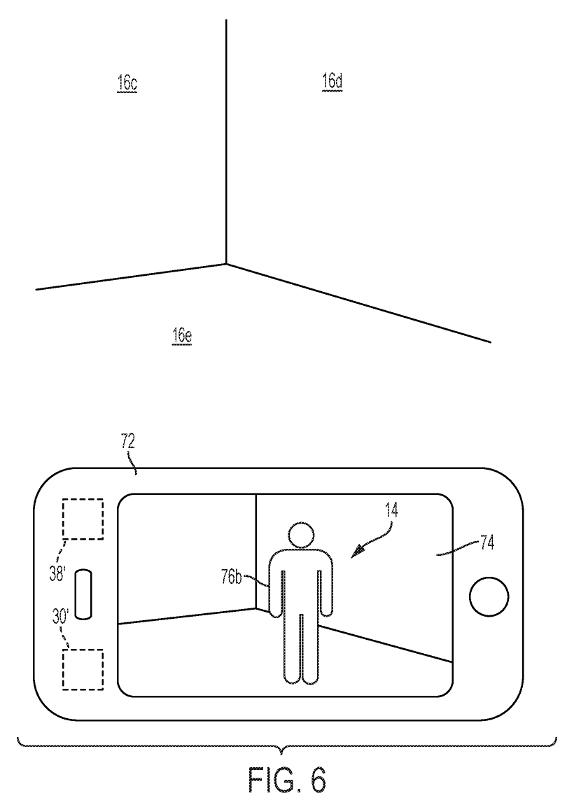

It is to be appreciated that the location associated with the virtual sound source 14 may be an empty space in the real-world environment, or occupied by a real object. In either event, the system 10 simulates a sound signal that is perceived by the user as originating from the designated location without that sound being actually produced by the environment or an object at that location. If a visual augmentation device is used as part of the system 10 (such as via the display of a smartphone or other mobile computing device, as discussed in more detail with respect to FIG. 5), the system 10 may be arranged to create a virtual avatar as a visual augmentation that is associated with, and/or represents, the virtual sound source 14. As one particular non-limiting example, if the virtual sound source 14 includes speech, a virtual avatar (e.g., image, animation, three-dimensional model, etc.) of a person talking may be used to represent the virtual sound source 14.

The system 10 also determines a location of the headphone assembly 12, the user wearing the headphone assembly 12, and one or more real objects in the environment surrounding the user, such as a wall 16a or 16b in FIG. 2. The reference numeral 16 may be used herein to refer generally to the various embodiments of the acoustically reflective objects or surfaces (e.g., the “object 16” or “reflective object 16”), with alphabetic suffixes (e.g., ‘a’, ‘b’) utilized to identify specific instances or examples for the object 16. Similar alphabetic suffixes may be used in a similar manner with respect to other components, features, or elements discussed herein. While the walls 16a and 16b are provided as specific examples, it is to be appreciated that any potentially acoustically reflective object in the real-world environment may be utilized as the object 16, such as a wall, floor, ceiling, person, automobile, flora, fauna, etc. It is noted that since sound reflects off of the surfaces of objects, any reference to “objects” herein is also applicable to and intended to include surfaces of objects.

In one embodiment, the location of the user is determined as the location of the headphone assembly 12, or vice versa, since the user is presumably wearing the headphone assembly 12. Accordingly it should be appreciated that “location of the user” as used herein can be determined by directly identifying the location of the user, or indirectly by determining the location of some other device expected to be held, carried, or worn by the user, such as the headphone assembly 12, or a smartphone or other mobile device associated with to the user.

It is to be appreciated that the locations of the user, the headphone assembly 12, the virtual sound source 14, and/or the object 16 may be determined as a global or absolute position relative to some global coordinate system, and/or as relative positions based on distances between and orientations of these entities with respect to each other. In one embodiment, relative distances and/or orientations between the entities are calculated from a global coordinate system by calculating the difference between each location. As discussed above with respect to FIG. 1, the system 10 may also determine an orientation or angle of the headphone assembly 12 and/or the virtual sound source 14 (e.g., α and/or θ) to facilitate the calculation of HRTFs that most accurately simulate sound from the location associated with the virtual sound source 14. As one example, a user may desire to use the headphone assembly 12 so as not to disturb others with loud sound, but to set the virtual sound source at the location of their stereo speakers or other location in a room so as to simulate the sound as if it were coming from their stereo system, but without creating noise perceivable to others that are not wearing the headphone assembly 12.

Regardless of how the various locations are determined, the locations can be used to determine a distance X1 corresponding to a direct sound path 18 from the virtual sound source 14 (namely, the physical location associated with the virtual sound source 14) to the headphone assembly 12. The system 10 also uses the determined locations to further determine one or more reflected sound paths, generally referred to with the reference numeral 20. Namely, FIG. 2 illustrates a first reflected sound path 20a and a second reflected sound path 20b, although any number of reflected sound paths 20 may be used in other embodiments. If left and right speakers are included by the headphone assembly 12, then the system 10 can generate a set of left and right HRTFs for each of the direct sound path 18 and the reflected sound paths 20.

As the reflected sound paths 20 represent reflected sound, each reflected sound path 20 is simulated to include a reflection from the corresponding reflective object 16. For example, the reflection may be indicated at or by a reflection point, generally referred to with the reference numeral 22, on an acoustically reflective object in the environment. It is noted that sound from real sound sources reflects off the surface of objects, not just a single point, as illustrated and described with respect to the reflection points 22. However, since the sound produced by the virtual sound source 14 is simulated, the reflections of the sound off of the objects 16 are also simulated. For this reason, the reflection points 22 may be utilized if convenient, e.g., to simplify calculations and/or representations related to the reflected sound paths 20 or other characteristics of the reflected sound. Thus, with respect to FIG. 2, the first reflected sound path 20a simulates sound originating at the virtual sound source 14 and reflecting off the wall 16a, representatively at a reflection point 22a, before arriving at the headphone assembly 12. Similarly, the second reflected sound path 20b simulates sound originating at the virtual sound source 14 and reflecting off the wall 16b, representatively at a reflection point 22b, before arriving at the headphone assembly 12.

It is to be appreciated that the reflected sound paths 20a and 20b in FIG. 2 represent first early reflections, but that secondary or higher order reflections, i.e., sounds reflecting off multiple surfaces before reaching the headphone assembly 12, may also be calculated and utilized by the system 10. For example, a reflected sound path 23 shown in dotted lines in FIG. 2 may be simulated for sound originating at the location of the virtual sound source 14 that first reflects off the wall 16a and then reflects off the wall 16b, before reaching the headphone assembly 12. Similarly, any number of reflections off any number of objects may be simulated according to the embodiments disclosed herein.

Each reflected sound path 20a and 20b includes a first segment having a distance X2 and a second segment having a distance X3 (thus, the sum of distances X2a and X3a defining a total length of the first sound path 20a and the sum of the distances X2b and X3b defining a total length of the second sound path 20b). It is to be appreciated that instead of calculating the distances X2 and/or X3 directly, the reflected sound paths 20 can be analogized by creating a copy (generally referred to herein with the reference numeral 24) of the virtual sound source 14 mirrored (reflected) with respect to the object 16 causing that reflection. For example, in FIG. 2, a mirrored or reflected copy 24a of the virtual sound source 14 is shown mirrored with respect to the wall 16a, while a mirrored or reflected copy 24b of the virtual sound source 14 is shown mirrored with respect to the wall 16b. Via the known locations of the virtual sound source 14 and the walls 16a and 16b, the physical location corresponding to the mirrored copies 24 can be determined and the direct path from the mirrored copies 24 to the headphone assembly 12 used as an analog to the reflected sound path 20, since the segments having the lengths X2 are also mirrored. It is to be appreciated that the mirrored copies 24 may be mirrored or reflected any number of times off any number of reflective surfaces in order to simulate higher-order reflections (e.g., such as the reflected sound path 23, which represents sound reflecting off both the wall 16a and the wall 16b).

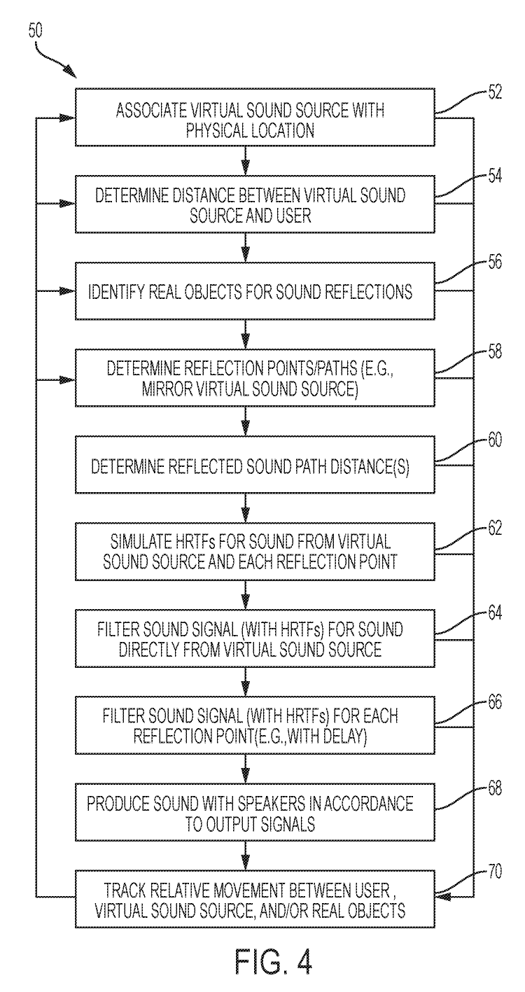

One embodiment for the system 10 is shown in more detail in FIG. 3, in which the headphone assembly 12 includes a first (e.g., left) speaker 26L, and a second (e.g., right) speaker 26R, collectively or generally “the speakers 26”. It is to be appreciated that in some embodiments, the headphone assembly 12 may include only one of the speakers 26, e.g., be arranged to fit on, at, or in only one ear of the user. The speakers 26 may include any device or component configured to produce sound, such as an electro-acoustic transducer. The headphone assembly 12 may also include a signal processing circuit 28, which creates an output signal for each of the speakers 26 (e.g., a left output signal for the left speaker 26L and a right output signal for the right speaker 26R). To this end, the signal processing circuit maybe include may include filters or other signal processing components for modifying a sound signal in a desired manner, such as by applying one or more HRTFs, active noise cancellation, or some other functionality to a sound signal.

The sound signal processed by the signal processing circuit 28 may be generated by a controller 30. The controller 30 includes a processor 32, a memory 34, and/or a communication module 36. The processor 32 may take any suitable form, such as a microcontroller, plural microcontrollers, circuitry, a single processor, or plural processors configured to execute software instructions. The memory 34 may take any suitable form or forms, including a volatile memory, such as random access memory (RAM), or non-volatile memory such as read only memory (ROM), flash memory, a hard disk drive (HDD), a solid state drive (SSD), or other data storage media. The memory 34 may be used by the processor 32 for the temporary storage of data during its operation. Data and software, such as the algorithms or software necessary to analyze the data collected by the sensors of the system 10, an operating system, firmware, or other application, may be installed in the memory 34. The communication module 36 is arranged to enable wired or wireless signal communication between the controller 30 and each of the other components of the system 10, particularly if the components of the system 10 are implemented as one or more remote devices separate from the headphone assembly 12. The communication module 36 may be or include any module, device, or means capable of transmitting a wired or wireless signal, such as but not limited to Wi-Fi (e.g., IEEE 802.11), Bluetooth, cellular, optical, magnetic, Ethernet, fiber optic, or other technologies. The communication module 36 may include a communication bus or the like, e.g., particularly in embodiments in which some or all of the components of the system 10 are integrated into the headphone assembly 12 and/or wherein the system 10 is arranged as a single integrated unit.

The controller 30 is configured to perform or assist in performing any of the determinations or calculations discussed herein. For example, with respect to FIG. 2, as discussed above, the controller 30 may be configured to set, obtain, or otherwise determine the location associated with the virtual sound source 14, as well as to generate, store, or transmit the sound signal associated with the virtual sound source 14. The controller 30 may also be used to determine the locations, orientations, and/or distances discussed with respect to FIG. 2, such as by calculating the locations and/or distances from position data (discussed in more detail below) corresponding to the user, the headphone assembly 12, the virtual sound source 14, the object 16, etc. Once the locations, orientations, and/or distances are calculated, the controller 30 may also be configured to generate an HRTF for each sound path-speaker combination. For example, if the headphone assembly 12 includes both the left speaker 26L and the right speaker 26R, then the controller 30 can generate a first left HRTF for the left speaker 26L simulating sound from the virtual sound source 14 along the direct sound path 18, a second left HRTF for the left speaker 26L simulating sound reflected at the reflection point 22a from the virtual sound source 14 along the reflected sound path 20a, and a third left HRTF for the left speaker 26L simulating sound reflected at the reflection point 22b from the virtual sound source 14 along the reflected sound path 20b. A similar set of right HRTFs can be made for the user's right ear and/or the right speaker 26R corresponding to the direct path 18, the reflected sound path 20a, and the reflected sound path 20b. Additionally, left and/or right HRTFs can be made for any number of other virtual sound sources and/or reflected sound paths.

To collect position data usable by the controller 30 to calculate the aforementioned locations, orientations, and/or distances, the system 10 may include a localizer 38. The localizer 38 includes any sensor, device, component, or technology capable of obtaining, collecting, or generating position data with respect to the location of the user, the headphone assembly 12, and the object 16, or the relative positions of these entities with respect to each other. The localizer 38 may include a rangefinder, proximity sensor, camera, or other device embedded in the headphone assembly 12. The localizer 38 may be embedded in the headphone assembly 12, or included by a remote device separate from the headphone assembly 12. For example, the localizer 38 may detect the reflective objects 16 by way of a transmitter and receiver configured to generate a signal and measure a response reflected off nearby objects, e.g., ultrasonic, infrared, or other signal. In one embodiment, the localizer 38 includes a camera, and the controller 30 includes an artificial neural network, deep learning engine, or other machine learning algorithm trained to detect the object 16 from the image data captured by the camera. In one embodiment, the localizer 38 includes a global positioning system (GPS) antenna or transponder, e.g., embedded in the headphone assembly 12 or otherwise carried by the user (such as in a smartphone). In one embodiment, the controller 30 only selects objects to be reflective objects 16 if they are within some threshold distance of the virtual sound source 14.

The system 10 may additionally include a motion tracker 40 that is configured to track motion of the user, particularly, the orientation of the user. In other words, since the HRTFs characterizing the sound received by the user at each ear is at least partially defined by the orientation of the user's ears with respect to the source of sound, the motion tracker 40 may be used to track the direction in which the user's head (and/or the headphone assembly 12) is facing in order to better approximate the HRTFs for that user (and/or the speakers 26). In one embodiment, motion of the user is indirectly tracked by monitoring motion of the headphone assembly 12, or some other device held, carried, or worn by the user.

The motion tracker 40 may include sensors embedded into or integrated with the headphone assembly 12 to track motion of the headphone assembly 12, such as a proximity sensor utilizing ultrasonic, infrared, or other technologies, cameras, accelerometers, gyroscopes, etc. In one embodiment, the motion tracker 40 includes a nine-axis inertial motion sensor. In one embodiment, the motion tracker 40 includes at least one sensor external to the headphone assembly 12. For example, the motion tracker 40 may include a camera system for tracking one or more elements of the user and/or the headphone assembly 12. In one embodiment, the motion tracker 40 includes a tag or marker (embedded in the headphone assembly 12 and/or otherwise carried or worn by the user) that is tracked by one or more external cameras, e.g., as is commonly used to perform motion capture, or mo-cap, in the film and videogame industries.

It is to be appreciated that both the localizer 38 and the motion tracker 40 are arranged to track, monitor, or detect the relative positions of the user, the headphone assembly 12, the virtual sound source 14, and/or the object 16. In other words, the data or information collected and/or generated by localizer 38 and the motion tracker 40 can be used, e.g., by the controller 30, to determine whether relative motion has occurred between any of these entities. In this way, the positions of each of these entities can change and the system 10 is capable of reacting accordingly and in essentially real-time. For example, as the user walks about an environment, the localizer 38 can continuously recalculate the distance between the user and the object 16, while the motion tracker 40 monitors the relative orientation of the user's head (and/or the headphone assembly 12). As another example, the controller 30 can change the location of the virtual sound source 14 at will, and the data collected by the localizer 38 and/or the motion tracker 40 used to generate direct sound paths, reflected sound paths, and HRTFs from the new location of the virtual sound source 14.

Systems that may be useful in some embodiments for creating the localizer 38 and/or the motion tracker 40 include the system marketed by Microsoft under the name Kinect, or the systems marketed by Google under the name Project Tango, and/or ARCore. The Kinect and Tango systems both utilize a combination of specialized cameras in order to detect objects, such as people, walls, etc. In particular, these systems include a visual camera coupled with an infrared camera to determine depth or distance, which may be utilized in both rangefinding and motion tracking applications. Those of ordinary skill in the art will readily recognize any other number of systems that can be utilized.

The system 10 may include an acoustic characteristic detector 42 for collecting or generating data relevant to at least one acoustic parameter or characteristic of the object 16 or the environment in which the user and the object 16 are located. In one embodiment, the detector 42 is arranged with or as a sensor to collect data related to the reverberation time and/or acoustic decay characteristics of the environment in which the user is located. For example, the detector 42 may produce (e.g., “ping”) a specified sound signal (e.g., outside of the range of human hearing if desired) and measure the reflected response (e.g., with a microphone). In one embodiment, an absorption coefficient is calculated from the reverberation time or other characteristics of the environment as whole, and applied to the object 16 as an approximation. If the sound signal is specifically directed or aimed at the object 16, then the differences between the original signal and the initially received reflections can be used to calculate an absorption coefficient of the object 16.

It is to be appreciated that the components of the system 10 as shown in FIG. 3 can be integrated, combined, separated, modified, and/or removed as desired. For example, the signal processing circuit 28 and the controller 30 may share some common components and/or the signal processing circuit 28 can be integrated as part of the controller 30, while in other embodiments the signal processing circuit 28 and the controller 30 are separate assemblies. Similarly, the controller 30 may be included by the headphone assembly 12, the localizer 38, the motion tracker 40, etc., or may be part of a separate or remote device that is in communication with any of these components (e.g., via the communication module 36). Non-limiting examples for remote devices include a smartphone, tablet, or other mobile device, a computer, server, or designated computing hardware, e.g., implemented via networked or cloud infrastructure, an external camera or other sensor, etc. In one embodiment, the system 10 includes multiple of the controllers 30 with at least one integrated with the headphone assembly 12 and another as part of a remote device. As another example, some or all of the components of the acoustic characteristic detector 42 may be combined with the localizer 38. For example, an ultrasonic or similar proximity sensor may be used both for rangefinding and for producing the soundwave necessary to assess the absorption characteristics of an environment. Additionally, the localizer 38 may include a camera and the controller 30 may include an artificial neural network or other deep learning algorithm may be used to identify objects in images captured by the camera, such that recognized objects are assigned an absorption coefficient based on predetermined values, e.g., stored in a lookup table in the memory 34, which correlate a coefficient to each known object.

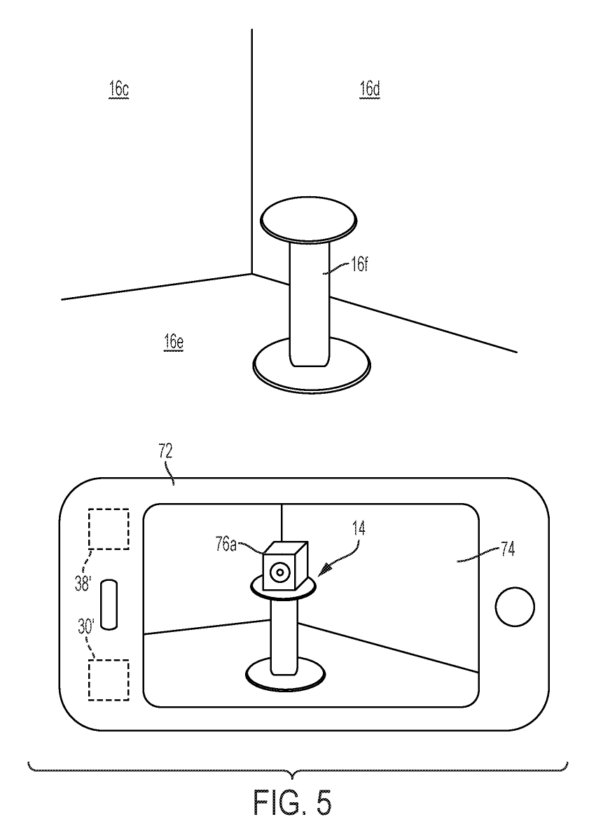

While methods of operating the system 10 can be appreciated in view of the above description, FIG. 4 includes a flowchart depicting a method 50 to further aid in the current disclosure. At step 52, a virtual sound source (e.g., the virtual sound source 14) is associated with a physical location. At step 54, the distance (e.g., the distance X1) between the virtual sound source and the user is determined (e.g., utilizing the controller 30). As noted above, step 54 may include using the headphone assembly 12, a smartphone, or other device worn or carried by the user as a proxy for the user in calculating the distance.

At step 56, any number of acoustically reflective real objects (e.g., the object 16) in the environment surrounding the user are identified or detected. For example, step 56 may be achieved via use of the localizer 38 scanning or probing the environment with one or more of its sensors. The controller 30 may be configured with algorithms or functions that result in the controller 30 not selecting any object that is less than a threshold size, e.g., in detectable surface area or in one or more detected dimensions. As another example, the localizer 38 may include a camera and the controller 30 may include an artificial neural network or other deep learning mechanism that is trained with image-based object recognition capabilities, such that the controller 30 is configured to select only objects that it recognizes. In one embodiment, step 56 includes the localizer 38 downloading or generating a map or other data representative of the environment in which the user is located. For example, the localizer 38 may be configured to retrieve GPS or map data from an internet or other database. As one specific example, the Maps product by Google identifies three dimensional data for various objects, such as buildings, trees, etc. which may be retrieved by the localizer 38 and utilized to set the boundaries used to identify or define the objects 16.

At step 58, paths for reflected sound (e.g., the reflected sound paths 20) and points on the acoustically reflective real objects from which the sound is reflected (e.g., the reflection points 22) are determined (e.g., by the controller 30 utilizing the position data collected by the localizer 38). Step 58 may include creating copies of the virtual sound source that are mirrored with respect to the acoustically reflective objects (e.g., the mirrored copies 24). At step 60, the distance of the reflected sound path, and/or one or more segments comprising the reflected sound path are determined. For example, the reflected sound path may include a distance between the user (or other proxy) and the mirrored copies generated in step 58. The reflected sound path may additionally or alternatively include multiple segments such as a first segment from the virtual sound source to the reflection point (e.g., the distance X2) and/or a second segment from the reflection point to the user (e.g., the distance X3).

At step 62, HRTFs are generated (e.g., via the controller 30) for each speaker (e.g., the speakers 26L and/or 26R) to simulate sound originating from the virtual sound source, and as reflected from the acoustically reflective object at each of the reflection points. Step 62 may include analyzing data collected by one or more sensors of a motion tracker (e.g., the motion tracker 40) in order to determine an orientation of the user. An orientation of the virtual sound source 14 can be virtually set by the controller 30 and also utilized in calculating the HRTFs.

At step 64, one or more “direct” output signals are generated (e.g., by the signal processing circuit 28) to represent the sound directly coming to the user from the virtual sound source. The output signals are generated by processing the desired sound signal (representing the sound being virtually emitted by the virtual sound source, e.g., as generated by the controller 30) according to the HRTFs generated in step 62 and any other desired signal processing. The number of output signals generated in step 62 can be equal to the number of speakers, i.e., with one output signal for each of the speakers 26, with each of the output signals processed by a different one of the HRTFs that corresponds to the intended speaker.

At step 66, one or more “reflected” output signals are generated similarly to step 64 but representing the sound coming to the user as reflected at each of the reflection points. In addition to applying the HRTFs generated in step 62, step 66 may include applying an absorption coefficient (e.g., generated by the controller 30 using the data gathered by the detector 42) for the real objects reflecting the virtual sound, or generally for the environment in which the user and the acoustically reflective objects are located. Additionally, since the reflected path of sound is expected to be longer than the direct sound path, step 66 may include delaying the reflected output signals by an amount of time equal to a difference between the length of the reflected path and the length of the direct path divided by the speed of sound. Typically, the human brain interprets any reflected sounds received by the ears within approximately 40 ms of the original to be essentially included as part of the original sound. In this way, step 66 may include not outputting the reflected output signal if the calculated delay is greater than about 40 ms. However, in other embodiments, output signals having greater than a 40 ms delay are specifically included in order to induce an echo effect, which may be particularly useful in simulating the sound characteristics for large open rooms, such as arenas or theatres, and thus advantageous for improving sound externalization in this type of environment.

At step 68 one or more speakers (e.g., the speakers 26) produce sound in accordance with the output signals generated in steps 64 and 66. The output signals intended for each speaker can be summed (e.g., by the signal processing circuit 28) before being sent to the respective ones of the speakers 26. As discussed above, due to the application of the HRTFs, particularity with respect to the HRTFs from the reflection points (e.g., the reflection points 22) on the acoustically reflective objects (e.g., the walls 16a and 16b, or other instances of the object 16), the externalization of the sound received by the user is significantly improved. By use of the HRTFs from the reflection points, the sound produced by the headphone assembly 12 includes acoustic characteristics specific to the actual environment in which the user is located, which the user's brain “expects” to hear if sound were created by a real object at the location of the virtual sound source 14. Advantageously, the simulation and synthetic or artificial insertion of the first early reflections of the virtual sound source from real objects in the environment (e.g., via the reflection paths 20) helps to convince the user's brain that the sound is occurring “external” to the user, at the location associated with the virtual sound source 14.

Step 68 proceeds to step 70 at which relative movement between the user, the virtual sound source, and/or the acoustically reflective objects is tracked. In response to any such relative movement, the method 50 can be returned to any of previous steps 52, 54, 56, or 58 in order to recalculate any of the corresponding locations, orientations, distances, HRTFs, or output signals. Additionally, each of the steps previous to step 68 can immediately proceed to step 70. In other words, the system 10 can be arranged in accordance with the method 50 to be constantly, e.g., in real-time, monitoring the real-world environment about the user, the acoustically reflective objects in the environment, and/or the user's location in the real world environment in order to update the sound produced by the speakers. In this way, the system 10 is able to dynamically change the output signal as the user moves (e.g., as determined from the data collected by the localizer 38), the user rotates their head (e.g., as determined from the data collected by the motion tracker 40), the virtual sound source 14 is moved (e.g., by the controller 30 setting a new location for the virtual sound source 14), the object 16 moves (e.g., a nearby car forming the object 16 drives away or a window or door in a wall forming the object 16 is opened), etc.

It is to be appreciated that other sensory modalities can be augmented in addition to the acoustic augmentation achieved in accordance with the above-described embodiments. One example includes visual augmented reality elements, although touch (haptic feedback), smell, taste, or other senses may be augmented if desired. To this end, FIGS. 5-6 illustrate specific embodiments in which multiple sensory modalities, namely, sound and sight, are both virtually augmented.

In FIG. 5, a physical environment, e.g., a room, is illustrated having a first wall 16c, a second wall 16d, a floor 16e, and a pedestal 16f. The system 10, when used in the environment of FIG. 5, may detect any or all of these objects to form an instance of an acoustically reflective object (the object 16) from which the sound from a virtual sound source can be reflected. In this embodiment, a smartphone 72 is included as an example of a supplemental augmentation device, and may form a part of the system 10. It is to be appreciated that any other device having a display capable of producing a computer generated visual element, e.g., “smart glasses”, tablets, or other computing devices, can be utilized in lieu of or in addition to the smartphone 72.

In the embodiment of FIG. 5, the smartphone 72 comprises a controller 30′ that at least partially defines the controller 30 (e.g., singly comprises the controller 30 or is one of several controllers that together comprise the controller 30). Additionally, the smartphone 72 includes a camera 38′, which at least partially forms the localizer 38 for this embodiment. The smartphone 72 includes a display or screen 74 through which visual elements of augmented reality can be displayed. For example, the smartphone 72 is illustrated in the foreground of FIG. 5, thus generally representing the perspective of a user holding the smartphone 72 and observing the environment in front of the user, as captured by the camera 38′, in the display 74.

In addition to the acoustically reflective objects in the environment, the display 74 also shows a virtual avatar 76a to visually represent the virtual sound source 14. The virtual avatar 76a in this example takes the form of a loudspeaker, but any other imaginable shape or three-dimensional virtual construct may be utilized. The virtual avatar 76a can be created by the system 10 (e.g., via the controller 30′) to represent the virtual sound source 14 and create a visual cue to the user regarding the location of the virtual sound source 14. For example, if the loudspeaker avatar of FIG. 5 is utilized, the sound signal may include music, which will be perceived by the user as emanating from the location of the avatar 76 shown to the user in the display 74, although the loudspeaker does not physically exist. In this way, a user wearing the headphone assembly 12 and viewing their environment through the smartphone 72 (or the display of another visual augmentation device) would see the avatar 76 depicting a loudspeaker sitting on the pedestal 16f in the display 74.

It is to be appreciated that virtual avatars can take any shape or form. For example, FIG. 6 illustrates a similar scenario to FIG. 5 in which the smartphone 72 is capturing depicting a room on the display 74 as captured by the camera 38′. Without the display 74, the room appears to be empty, but the display 74 displays a virtual avatar 76b in the form of a person for the virtual sound source 14 in FIG. 6. For example, if the sound signal associated with the virtual sound source 14 (and being played by the headphone assembly 12) is a song, the person depicted by the display 74 may appear as the singer or musician that recorded that song.

As a result of the calculated HRTFs, the user would perceive the sound produced by the speakers 26 of the headphone assembly 12 as if it were coming from the indicated location of the virtual avatar. As the user moves about the room, orients their head to examine the virtual avatar , or as the controller moves the location of the virtual avatar and/or animates the virtual avatar, e.g., to move it (and the corresponding location virtual sound source) about the room, the system 10 can be configured to react, e.g., in real-time, as discussed above with respect to step 70 of the method 50, to recalculate the HRTFs so that the sound is continually perceived as coming from the particular location indicated by the virtual avatar and associated with the virtual sound source 14. It is also to be appreciated that a virtual avatar does not need to be utilized. For example, the virtual sound source 14 may be set to any location in the environment, such as an empty spot on the floor 16e, or to correspond to the location of a physical object, such as the pedestal 16f itself (without the avatar 76a). Those of ordinary skill in the art will recognize additional virtual elements and other sensory augmentations that can be utilized with the system 10.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

1. A sound externalization system, comprising:
a localizer configured to collect information related to a first location of a user in an environment and a second location of an acoustically reflective surface in the environment;
a controller configured to:
determine a third location of a virtual sound source in the environment;
generate a first left head related transfer function (HRTF) and a first right HRTF that simulate characteristics of sound radiated from the virtual sound source directly to the user;
determine a reflected sound path from the virtual sound source to the user that includes reflection of sound by the acoustically reflective surface;
generate a second left HRTF and a second right HRTF that simulates characteristics of sound from the reflective surfaces to the user, wherein the second left HRTF and second right HRTF are different from the first left HRTF and first right HRTF; and
generate a sound signal corresponding to the virtual sound source.

2. The system of claim 1, wherein the controller is configured to determine the reflected sound path by determining a fourth location corresponding to a mirrored reflection of the virtual sound source by the reflective surface, the reflected sound path comprising a direct path from the fourth location to the first location.

3. The system of claim 1, including a plurality of the acoustically reflective surfaces, wherein the reflected sound path represents at least one higher-order reflection off of two or more of the acoustically reflective surfaces.

4. The system of claim 1, further comprising a headphone assembly configured to be worn by the user and having:
a left speaker and a right speaker; and
a signal processing circuit configured to create first left, second left, first right, and second right output signals, respectively, by filtering the sound signal with the first left, second left, first right, and second right HRTFs;
wherein the left speaker is configured to produce sound in accordance with the first and second left output signals and the right speaker is configured to produce sound in accordance with the first and second right output signals.

5. The system of claim 4, wherein the signal processing circuit is configured to sum the first and second left output signals and to sum the first and second right output signals.

6. The system of claim 1, further comprising an acoustic characteristic detector configured to collect data related to reverberation characteristics of the environment or the acoustically reflective surface, wherein the controller is configured to determine an absorption coefficient for the environment or for the acoustically reflective surface from the data.

7. The system of claim 1, further comprising a display configured to display an avatar representing the virtual sound source at the third location when the third location is viewed through the display.

8. The system of claim 7, wherein the display is included by in a smartphone or other mobile computing device.

9. The system of claim 1, wherein the localizer comprises a rangefinder, a proximity sensor, an ultrasonic sensor, a camera, an infrared camera, or a combination including at least one of the foregoing.

10. The system of claim 1, wherein the localizer includes at least one sensor external to or integrated in the headphone assembly.

11. The system of claim 1, wherein the localizer is configured to obtain electronic data representative of a map of the environment that indicates surfaces of the acoustically reflective surface.

12. The system of claim 1, wherein the acoustically reflective surface includes one or more walls, floors, ceilings, or a combination including at least one of the foregoing.

13. The system of claim 1, further comprising a motion tracker configured to collect data related to an orientation of the user.

14. The system of claim 13, wherein the motion tracker includes a proximity sensor, an ultrasonic sensor, an infrared sensor, a camera, an accelerometer, a gyroscope, an inertial motion sensor, an external camera, or a combination including at least one of the foregoing.

15. The system of claim 13, wherein the controller is configured to determine one or more angles between the orientation of the user and a directionality of sound from the third location, from the reflective surface, or both, and the one or more angles are utilized by the controller when generating the first left, second left, first right, and second right HRTFs.

16. The system of claim 1, wherein the controller is configured to recalculate the first left, second left, first right, and second right HRTFs in response the system detecting relative movement between any combination of the user, the third location of the virtual sound source, and the acoustically reflective surface.

17. The system of claim 16, wherein the controller is configured to move the virtual sound source by changing the third location.

18. A sound externalization system, comprising:
a headphone assembly worn by a user;
a sensor configured to detect an acoustically reflective surface in an environment in which the user is located;
a controller configured to:
associate a first location in the environment with a virtual sound source;
determine a second location of the user;
determine reflected sound path simulating sound from the first location to the user that includes a reflection by the acoustically reflective surface at a third location;
generate a first head related transfer function simulating characteristics of sound traveling from the first location to the second location;
generate a second head related transfer function simulating characteristics of sound traveling from the third location to the second location, wherein the second head related transfer function is different from the first head related transfer function;
generate a sound signal for the virtual sound source;
generate a first output signal by filtering the sound signal with the first head related transfer function and a second output signal by filtering the sound signal with the second head related transfer function; and
a speaker of the headphone assembly configured to produce sound in accordance with the first and second output signals.

19. A method for externalizing sound from a headphone assembly worn by a user, comprising:
associating a virtual sound source with a physical location in an environment in which the user is located;
identifying one or more acoustically reflective surfaces in the environment;
determining a reflected sound path from the physical location to the user that includes a reflection by the acoustically reflective surface;
generating a first head related transfer function (HRTF) simulating characteristics of sound received by the user directly from the physical location;
generating a second HRTF simulating characteristics of sound received by the user from the reflection, wherein the second HRTF is different from the first HRTF;
generating a sound signal corresponding to the virtual sound source;
filtering the sound signal with the first HRTF to generate a first output signal;
filtering the sound signal with the second HRTF to generate a second output signal; and
producing sound with a speaker of the headphone assembly in accordance with the first and second output signals.

20. The method of claim 19, further comprising tracking relative movement between any combination of the user, the physical location associated with the virtual sound source, and the acoustically reflective surface, wherein the tracking occurs continuously during the method.
